(19) United States
(12) Patent Application Publication
(10) Pub. No.: US 2005/0092664 A1
(43) Pub. Date: May 5, 2005

(54) Improvised device for concentrating the aqueous solution and a pocess thereof

(76) Inventors: Pushpito Kumar Ghosh, Bhavnager (IN); Virendrakumar J. Shah, Bhavnager (IN); Jayant Butkrai Pandya, Bhavnager (IN)

Correspondence Address: LOWE HAUPTMAN GILMAN & BERNER, LLP, Suite 300, 1700 Diagonal Road, Alexandria, VA, 22314, US

(21) Appl. No.: 10/700,512

(22) Filed: Nov. 5, 2003

(51) Int. Cl. B01D 65/02

(52) U.S. Cl. 210/108; 210/110; 210/134; 210/321.65; 210/321.69

(57) ABSTRACT

The present invention relates to an improvised membrane-based device for speedier and effective concentrating of aqueous solution upto about 95%, as shown in FIGS. 1-4, a method of manufacturing an improved membrane-based device for speedier and effective concentrating of aqueous solution upto 95%, and also, an improved process of speedier and effective concentrating of the aqueous solution upto about 95% using the aforementioned membrane-based device, said process comprising steps of feeding the aqueous solution into the aqueous solution container, filtering the fed solution to remove suspended particles, passing the resultant filtered solution into a membrane module, segregating permeate and concentrate in the membrane module, and recycling the concentrate multiple times to obtain the highly concentrated final concentrate.

### FIELD OF THE PRESENT INVENTION

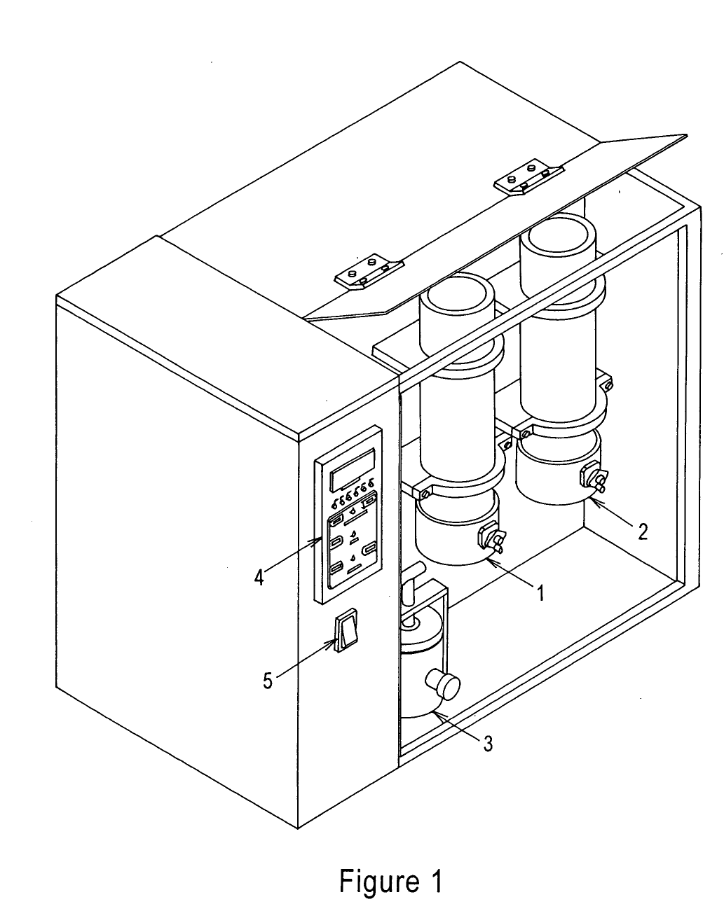

The present invention relates to an improvised membrane-based device for speedier and effective concentrating of aqueous solution upto about 95%, as shown in FIGS. 1-4, a method of manufacturing an improved membrane-based device for speedier and effective concentrating of aqueous solution upto 95%, and also, an improved process of speedier and effective concentrating of the aqueous solution upto about 95%, using the aforementioned membrane-based device, said process comprising steps of feeding the aqueous solution into the aqueous solution container, filtering the fed solution to remove suspended particles, passing the resultant filtered solution into a membrane module, segregating permeate and concentrate in the membrane module, and recycling the concentrate multiple times to obtain the highly concentrated final concentrate.

### BACKGROUND AND PRIOR ART REFERENCES OF THE PRESENT APPLICATION

As is well known to researchers working in the area of drug discovery research pertaining to screening of herbal extracts for bioactivity, the traditional method of processing the aqueous extract is to concentrate such extract to the maximum extent possible on a Buchi type rotavap and then remove remaining water by freeze drying. The main drawback of the method is that the process of water removal on a rotavap is slow and the extract is exposed to elevated temperatures for extended periods. It would therefore be highly desirable to overcome these drawbacks.

Reference may be made to the paper captioned “Membrane based chromatography is paving the way for high throughput biopharmaceutical processing” by T. N. Warner et al. in Modern Drug Discovery, February 2003, p 45, which states that in pharmaceuticals there is tremendous pressure to bring drugs to the market quickly and describes application of membrane chromatography for drug discovery research. Compared to traditional chromatography, membrane chromatography has 100-fold higher throughput and efficiency making it a compelling option for biopharmaceutical purification. The ion-exchange membranes used for the above purpose have micro pores that are modified with charged hydrophilic polymers These polymers are cross linked to the membrane pore surfaces. The cation exchanged membrane having sulphonic acid groups is capable of retaining proteins while allowing DNA, viruses and endotoxins to pass through, while anion exchange membrane having quaternary amine group retains DNA, viruses and endotoxins. No solution is reported, however, for speedier processing of crude herbal extracts for drug discovery research. Reference may be made to Ullman's Encyclopedia of Industrial Chemistry, Sixth Edition, 2002 Electronic Release wherein large scale applications of reverse osmosis membranes has been described. The important applications include: (i) the treatment of industrial effluents from electro plating industry; (ii) from pulp and paper industry; (iii) from the food processing industry; (iv) drug industry and biotechnology and (v) from textile industry; dyeing processes industry etc. The separation and concentration of solutions using reverse osmosis membranes at ambient temperature is the most relevant and advanced technique in use. Although many applications of RO for industrial processes is reported and RO is also used as part of the purification process for ultrapure water, no mention is made of its application for drug discovery research related to aqueous herbal extracts.

Reference may be made to the write up in C&E.News, Jun. 16, 2003, on the ACHEMA2003exhibition in Frankfurt, Germany where many companies displayed working models of membrane filtration systems which can be customized for variety of applications.

Thomas Zachrisson of Alfa Laval Engineering group in Tumba, Sweden in the ACHEMA 2003 exhibition displayed the plate and frame cross flow membrane filtration module M 39, which contained series of parallel flat sheet membranes mounted on the plates. It was pointed out that the modules are suitable for Ultrafiltration and nano-filtration of highly viscous products and fermentation broths. The membranes in the modules were developed to perform in the processing of antibiotics, enzymes, blood products and yeast extracts. However no unit was mentioned that is suitable for processing of aqueous herbal extracts for drug discovery research.

Grace Davison Membranes, division of Columbia, Md.-based W.R. Gace, reported the manufacture of a range of Organic Solvent Nano-filtration (OSN) membrane made of polyamide and are known as STARMEM. These membranes are stable to solvents, temperature and rejects 90% of solute molecules. These OSN membranes can separate antibiotics from organic solvents, exchanging high boiling-point solvents for low boiling-point one and separating catalysts from products in processes such as phase transfer catalysis and organo-metallic catalysis. However, no reference was made to any unit suitable for concentration of aqueous herbal extracts for drug discovery research.

Olaf Kiepe of Puron Company, Aachen, Germany exhibited membranes for water treatment at ACHEMA 2003 exhibition. The company manufactures active film of polyethersulphone supported on a polyester. The potential applications of these membranes includes municipal waste water treatment, drinking water production and other industrial applications.

Nathalie Garassino of KERASEP Company in the ACHEMA 2003 exhibition displayed tubular modules made from ceramic material which were lined with a film of Zirconia and titania membrane. The potential applications of these membranes include clarification of soft drinks, fruit juice and fermentation liquids, micro-filtration of milk and treatment of biodegradable waste water.

Conventionally, the concentration of any aqueous solution is carried out by evaporation either as in nature using solar energy or artificially through forced evaporation. Evaporation using solar energy is attractive as it utilises free energy and evaporation can be carried out close to room temperature. However, it necessitates that solutions are exposed to light which is a disadvantage when constituents are photolabile. Conventionally, the Rotavap is used for removal of solvents—including water—from solutions, especially in the scientific laboratory. This involves application of elevated temperatures—typically exceeding 65° C.—when solvents such as water have to be evaporated.

Aqueous herbal extracts, which are extensively studied for their potential bioactive properties, are typically processed in the laboratory using the Rotavap for concentration. Thereafter the concentrate is further subjected to freeze drying and then sampled for bioassay. One drawback of this method is that the throughput of research can be constrained by the rate at which extracts are concentrated in a Rotavap. Another drawback is that, by subjecting extracts to elevated temperatures, there is uncertainty as to whether constituents in the extract might be affected by exposure to such high temperatures for long durations, especially when the constituents are thermo-labile. Membrane-based dewatering has been used extensively in several industries such as the food and pharmaceutical industries as described in the prior art. However, the prior art literature survey and patent search did not reveal any membrane-based device for concentration of aqueous herbal extracts such as for the purpose alluded to above. Although this may seem obvious in view of the reported dewatering applications of membranes, it is equally true that researchers had continued to take recourse to the use of the rotavap because no suitable membrane-based device has ever been marketed for this purpose. On the other hand, when such a device base on thin film composite reverse osmosis spiral membrane module was fabricated by the inventors and given for drug discovery research purpose to leading laboratories in India, there was an overwhelming affirmation of the utility of the device as would be evident from the following comment of the Director of Central Institute of Medicinal & Aromatic Plants, Lucknow, India, a laboratory engaged for many years in such research: “The two units of water extractor/concentrator apparatus kindly provided to CIMAP are functioning very well. The units have been really useful in increasing output of water extracts being made at CIMAP.” Similar has been the response of many other laboratories to which the equipment of the present invention was provided. This compels the inventors to conclude that the device of the present invention for the intended application of concentration of aqueous herbal extracts is non-obvious and highly useful.

### OBJECTS OF THE PRESENT INVENTION

The main object of the present invention is to develop a device for concentrating aqueous solution, which obviates the above noted drawbacks.

Another object of the present invention is to develop a device, which enables the major part of concentration of aqueous extract to be carried out with a higher throughput than the conventional method of vacuum distillation in a rotavap.

Still another obje4ct of the present invention is to develop a process for dewatering the aqueous herbal extract solution.

Still another object of the present invention is to develop a device wherein the concentrated extract imbibes/retains the plant constituents, salts and vital bioactive molecules.

Yet another object of the present invention is to develop a device which can operate at ambient temperature and prevent degradation of bioactive molecules that are thermally less stable.

Yet another object of the present invention is to develop a device wherein the automatic washing cycle increases the potency and life of the membrane used.

A further object of the present invention is to develop a device, which can substantially reduce the overall time required to prepare plant extracts in desired form for bioassay. A further object is to make a device available for concentration of herbal extract at a cost lower than the conventional rotavap while enabling faster throughput under ambient condition.

A still further object of the present invention is to develop a device which can be scaled up for processing large volumes of potentially promising lead extracts and ultimately for commercial production of bioactive substances from aqueous plant extracts.

### SUMMARY OF THE PRESENT INVENTION

The present invention relates to an improvised membrane-based device for speedier and effective concentrating of aqueous solution upto about 95%, as shown in FIGS. 1-4, a method of manufacturing an improved membrane-based device for speedier and effective concentrating of aqueous solution upto 95%, and also, an improved process of speedier and effective concentrating of the aqueous solution upto about 95% using the aforementioned membrane-based device, said process comprising steps of feeding the aqueous solution into the aqueous solution container, filtering the fed solution to remove suspended particles, passing the resultant filtered solution into a membrane module, segregating permeate and concentrate in the membrane module, and recycling the concentrate multiple times to obtain the highly concentrated final concentrate.

### DETAILED DESCRIPTION OF THE PRESENT INVENTION

The present invention relates to an improvised membrane-based device for speedier and effective concentrating of aqueous solution upto about 95%, as shown in FIGS. 1-4, a method of manufacturing an improved membrane-based device for speedier and effective concentrating of aqueous solution upto 95%, and also, an improved process of speedier and effective concentrating of the aqueous solution upto about 95% using the aforementioned membrane-based device, said process comprising steps of feeding the aqueous solution into the aqueous solution container, filtering the fed solution to remove suspended particles, passing the resultant filtered solution into a membrane module, segregating permeate and concentrate in the membrane module, and recycling the concentrate multiple times to obtain the highly concentrated final concentrate.

The present invention provides an improvised membrane-based device for speedier and effective concentrating of aqueous solution upto about 95%, as shown in FIGS. 1-4, wherein the device comprises:

| Part No. | Description of the parts of the device |
|---|---|
| 1 | herbal extract solution container |
| 2 | permeate solution container |
| 3 | filter to remove suspended particle from feed extract |
| 4 | Panel for control of different operations |
| 5 | main power supply switch |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| 15 | fabric filter through which clear solution enters into the |
| | membrane module (7) |
| 16 | air bleeding valve which can be opened to remove any trapped |
| | air in the system |
| 17 | plastic body housing the membrane |
| 18 | thin film composite spiral membrane element for removal of |
| | water from extract under pressure |
| 19 | inlet for introducing the clear herbal extract solution |
| 20 | Concentrate outlet for recycling the extract to the extract |
| | container (1) |
| 21 | permeate outlet for sending the water to the permeate container |
| | (2) |
| 22 | Rubber ‘O’ ring |
| 23 | By-pass seal for allowing the extract solution to pass through |
| | the membrane |

Yet another embodiment of the present invention provides the device is particularly effective in concentrating herbal extracts.

Still another embodiment of the present invention provides the device can be scaled up without any change in basic design and operating parameters.

Yet another embodiment of the present invention provides the device maintains stability of the solution by functioning at room temperature, preferably about 25° C.

Still another embodiment of the present invention provides the device concentrates the aqueous solution without frothing.

Yet another embodiment of the present invention provides the concentrate retains all constituents of the solution.

Still another embodiment of the present invention provides the vertical container works as a reservoir for continuous supply of feed.

Yet another embodiment of the present invention provides the permeate container with outlet valve continuously removes water.

Still another embodiment of the present invention provides the filter vessel coupled with air bleeding valve enables removal of suspended particles and trapped air, respectively, thus, allows only clear solution to flow into the membrane module.

Yet another embodiment of the present invention provides the membrane module containing spiral thin film composite membrane allows water to pass while retaining other components, and the solution to circulate in the system.

Still another embodiment of the present invention provides the solenoid valves helps changing the path of aqueous solutions water during the drain/wash mode for operation.

Yet another embodiment of the present invention provides the pressure pump enables adequate pressure to be attained for continuous flow of aqueous solution.

Still another embodiment of the present invention provides the control panel coupled with ON and OFF switch helps concentrating the aqueous solution, and continuously washing the membrane for optimum life.

Yet another embodiment of the present invention provides the membrane module has length and diameter in the ratio of about 6:1.

Still another embodiment of the present invention provides the membrane has overall thickness ranging between 130 to 170 microns.

Yet another embodiment of the present invention provides the aqueous solution container has length and diameter in the ratio of about 4:I.

Still another embodiment of the present invention provides the permeate container has length and diameter in the ratio of about 4:1.

Yet another embodiment present invention provides the solenoid valves controls the direction of the flow in modes selected from a group comprising concentrate mode, drain mode, and wash mode.

One more embodiment of the present invention provides a method of manufacturing an improved membrane-based device for speedier and effective concentrating of aqueous solution upto 95%, wherein the said device is manufactured by assembling in manner as shown in FIGS. 1-4.

Yet another embodiment of the invention provides the device comprises aforementioned components in the manner as shown in figures.

An improved process of speedier and effective concentrating of the aqueous solution upto about 95% using a membrane-based device of FIGS. 1-4, said process comprising steps of:
a. feeding the aqueous solution into the aqueous solution container (1),
b. filtering (3) the fed solution to remove suspended particles,
c. passing the resultant filtered solution into a membrane module (7),
d. segregating permeate and concentrate in the membrane module, and
e. recycling the concentrate multiple times to obtain the highly concentrated final concentrate.

Still another embodiment of the present invention provides the device comprises aforementioned components in the manner as shown in figures.

Yet another embodiment of the present invention provides the process is particularly effective in concentrating herbal extracts.

Still another embodiment of the present invention provides the device can be scaled up without any change in basic design and operating parameters.

Yet another embodiment of the present invention provides the process is conducted at room temperature, preferably about 25° C.

Still another embodiment of the present invention provides the concentrate of the aqueous solution is without frothing.

Yet another embodiment of the present invention provides the concentrate retains all constituents of the solution.

Still another embodiment of the present invention provides the vertical container works as a reservoir for continuous supply of feed.

Yet another embodiment of the present invention provides the permeate container with outlet valve continuously removes water.

Still another embodiment of the present invention provides the filter vessel coupled with air bleeding valve enables removal of suspended particles and trapped air, respectively, thus, allows only clear solution to flow into the membrane module.

Yet another embodiment of the present invention provides the membrane module containing spiral thin film composite membrane allows water to pass while retaining other components, and the solution to circulate in the system.

Still another embodiment of the present invention provides the solenoid valves helps changing the path of aqueous solution/water during the drain/wash mode for operation.

Yet another embodiment of the present invention provides the pressure pump enables adequate pressure to be attained for continuous flow of aqueous solution.

Still another embodiment of the present invention provides the control panel coupled with ON and OFF switch helps concentrating the aqueous solution, and continuously washing the membrane for optimum life.

Yet another embodiment of the present invention provides the membrane module has length and diameter in the ratio of about 6:1.

Still another embodiment of the present invention provides the membrane has overall thickness ranging between 130 to 170 microns.

Yet another embodiment, of the present invention provides the aqueous solution container has length and diameter in the ratio of about 4:1.

Still another embodiment of the present invention provides the permeate container has length and diameter in the ratio of about 4:1.

Yet another embodiment of the present invention provides the solenoid valves controls the direction of the flow in modes selected from a group comprising concentrate mode, drain mode, and wash mode.

Still another embodiment of the present invention provides the process helps eliminate the hold-up volume.

Yet another embodiment of the present invention provides the process minimizes the membrane fouling.

Still another embodiment of the present invention provides the process prevents contamination of the solution.

The present invention relates to an improved process of concentration of aqueous herbal extracts. More particularly, the invention relates to membrane-based dewatering of such extracts at ambient temperature for speedier operation and reduced susceptibility of thermally labile constituents to thermal degradation. The system is further capable of unattended operation.

1. Membrane-based process for concentration of plant herbal extracts through a device which comprises:
(i) a main membrane module (7) having a semi-permeable membrane that is capable of permeating water while rejecting solute constituents embodied in a plastic body (17) and diaphragm type pressure pump (6) capable of channelizing the extract solution into the membrane module (7) after passing through the filter vessel (3) containing fabric filter (15) and one or more solenoid valves (8,9) capable of changing the path of the permeate and recycling the concentrated extract solution into the extract container (1).
(ii) the said combination of membrane module, the pressure pump in the rear chamber and the filter vessel being fixed adjacent to the extract and permeate containers in the front chamber of the device, the solenoid valves (10,11) mounted in the rear chamber capable of pushing the flow of solution from membrane module with air pressure to the extract container during the drain mode, the air being supplied from an external air compressor.
(iii) the said membrane module (7) being also provided with a pressure pump (6), a filter vessel (3) and plurality of solenoid valves (12,13) connected through a flexible tube to the water source for washing of the membrane during the wash mode

Yet another embodiment of the present invention, which is particularly useful for concentration of extracts that are aqueous and more preferably aqueous extracts that are not excessively viscous or oily and do not contain excessive quantities of osmotic pressure enhancing constituents.

Still another embodiment of the present invention, wherein the semi-permeable membrane is of the type suitable for reverse osmosis applications such as cellulose acetate, cellulose triacetate, cellulose blend, polyamide film and more preferably thin film composite reverse osmosis membrane with >95% salt rejection under normal test conditions and more preferably >99% salt reaction capability.

Yet another embodiment of the present invention, wherein the thin film composite membrane is embodied with ‘O’ ring and by-pass seal in a fiber reinforced plastic body/ABS plastic body.

Still another embodiment of the present invention, wherein the prime mover is such as a diaphragm type pressure pump for obtaining optimum flow.

Yet another embodiment of the present invention, wherein the filter vessel is such as a conventional filter with fabric filter.

Still another embodiment of the present invention, wherein the solenoid valves are such as conventional valves which help in changing the path of the flow.

Yet another embodiment of the present invention, wherein the device is capable of concentrating aqueous extract solution from 10-95% and more practically in the range of 50-80%.

Still another embodiment of the present invention, wherein the device capable of performing at ambient temperature is especially useful for concentration of thermally sensitive aqueous extracts.

Yet another embodiment of the present invention, wherein the particular design of the device suppresses froth formation during the concentration process and is therefore particularly beneficial when extracts contain froth promoting substances such as plant saponins where concentration of these extracts is extremely problematic through the conventional method of thermal concentration.

Still another embodiment of the present invention, wherein the device is capable of largely retaining the plant constituents, salts and vital bioactive molecules in the concentrated extract solution.

Yet another embodiment of the present invention, wherein permeate can be placed in the extract container for reprocessing to further minimise losses of organic matter in pereate to <0.5% n level.

Still another embodiment of the present invention, wherein the design is flexible for achieving permeate almost completely free (<0.1%) from plant substances by reprocessing permeate in a second RO module and further reprocessing permeate from second RO module in a third RO module while feeding back concentrate from each stage to the original extract container.

Yet another embodiment of the present invention, wherein the degree of concentration attainable can be enhanced by increasing the pump pressure while simultaneously increasing the rejection efficiency of the membrane and having a series of membrane modules for further minimising losses in eventual permeate.

Still another embodiment of the present invention wherein the device can be scaled up to process large volumes of aqueous herbal extract without significant change in basic design and operating parameters.

A membrane based device for aqueous herbal extract concentration substantially as herein described with references to the examples and drawings accompanying this specification.

It will be obvious to those skilled in the art that the device of the invention would be useful for concentration of other aqueous bioactive extracts such as microbial extracts, algal extracts and animal extracts.

The present invention relates to an improved process of concentration of aqueous herbal extracts using a membrane-based device. More specifically, it relates to concentration of extracts having volumes in the range of 1-20 L such as encountered in laboratory scale for drug discovery research. The device is a superior alternative to the rotavap conventionally used for such purposes. The major advantages are: (i) greater speed of concentration in most cases where the extract is not excessively viscous or oily and does not contain excessive quantities of osmostic pressure-enhancing constituents, (ii) ambient temperature operation that reduces susceptibility to thermal degradation of thermally labile constitutents in extracts, and (iii) elimination of the frothing problem frequently encountered for such extracts in a rotavap, especially when the extract contains froth-forming substances such as plant saponins. The concentrated retenate retains the vital herbal constituents, with neglible loss in the final permeate.

### DETAILED DESCRIPTION OF THE ACCOMPANYING DRAWINGS

The device of the present invention for herbal extract concentration consists of:
i. a vertical container which will work as a reservoir for continuous supply of feed extract
ii. a permeate container outlet valve for continuous removal of water
iii. a filter vessel coupled with air bleeding valve that enables removal of suspended particles and trapped air, respectively, and which allows only clear solution to flow into the membrane module
iv. a membrane module containing spiral thin film composite membrane, which allows water to pass while retaining other components, and the extract to circulate in the system.
v. solenoid valves for changing the path of extract/water during the drain wash mode for operation and during concentration, draining and washing processes.
vi. pressure pump, which enables adequate pressure to be attained for continuous flow of extract on membrane surface and flow of water during the washing process.
vii. a control panel coupled with ON and OFF switch for concentrating the aqueous herbal extract and continuously washing the membrane for optimum life.

FIG. 1 of the drawing represents the front elevation of the device

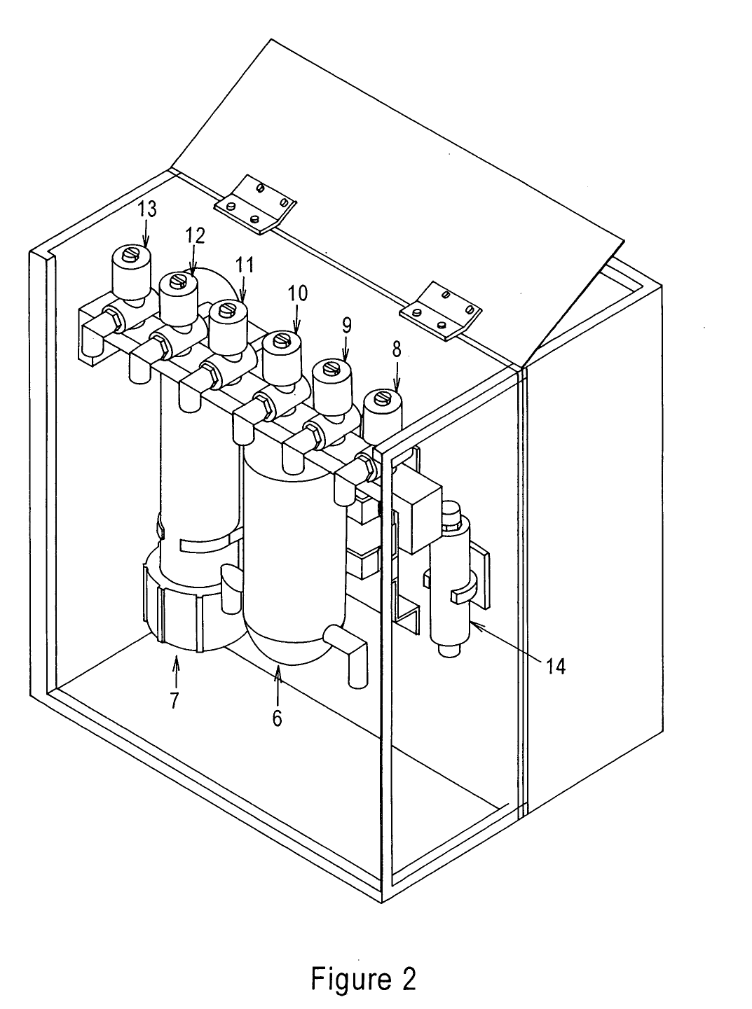

FIG. 2 of the drawing represent the rear elevation of the device

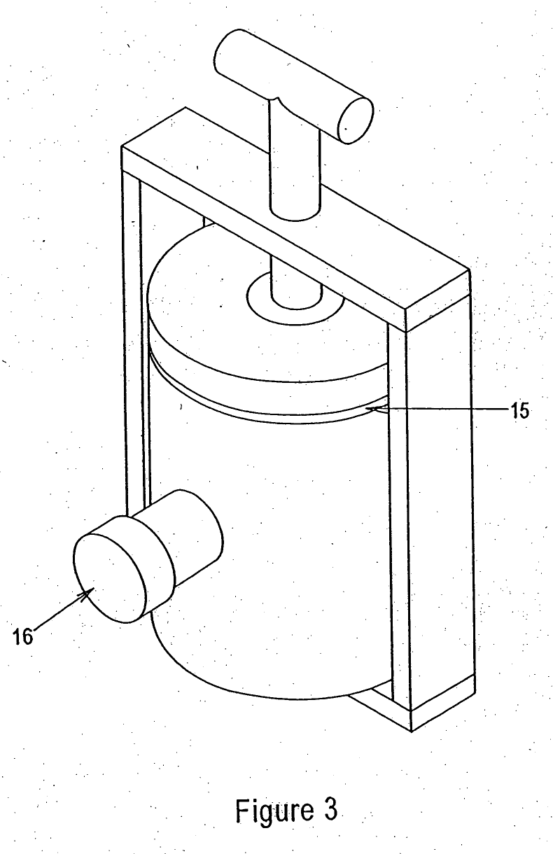

FIG. 3 of the drawing represent the filter vessel of the device coupled with air bleeding valve

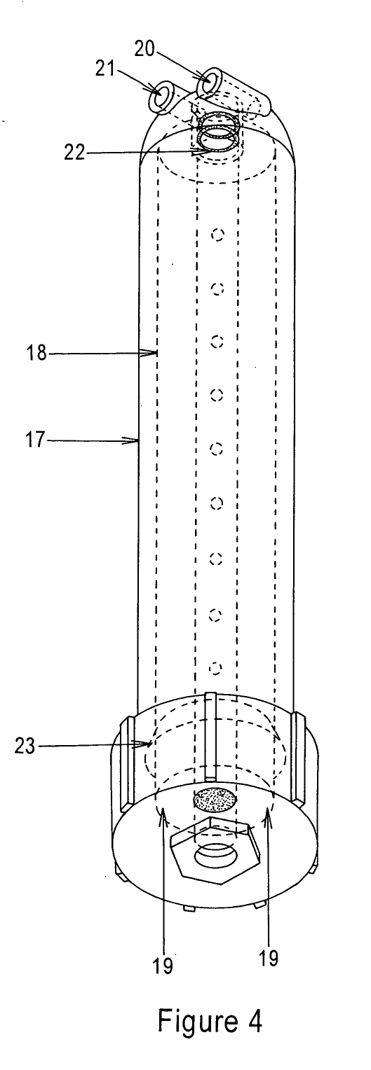

FIG. 4 of the drawing represent the membrane module of the device

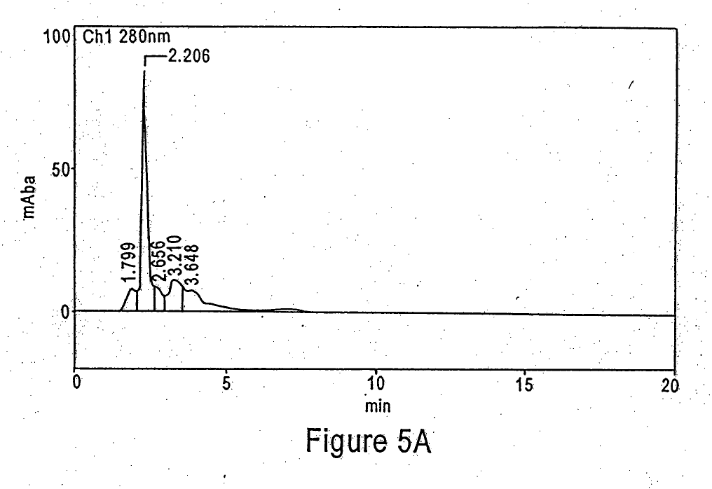

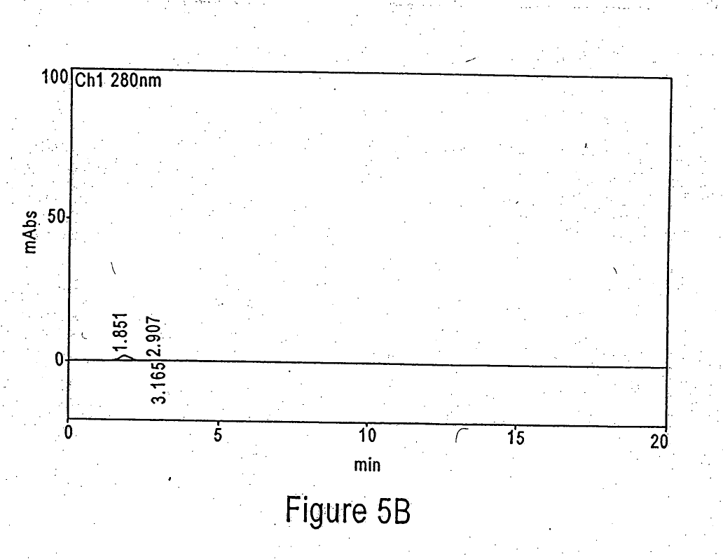

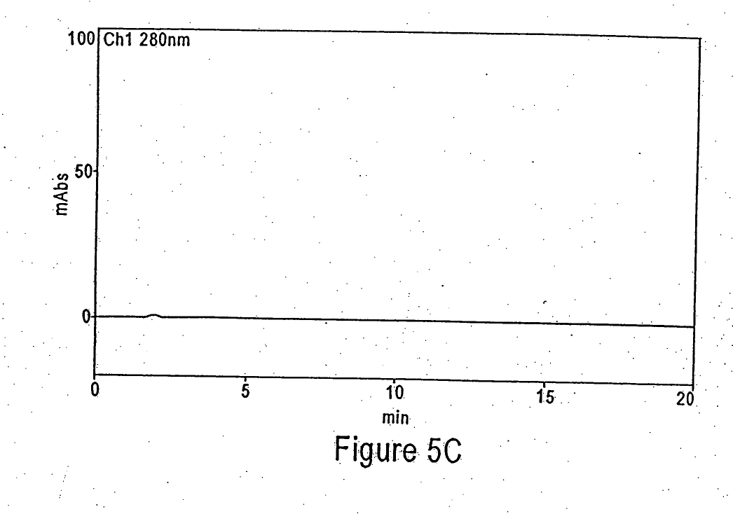

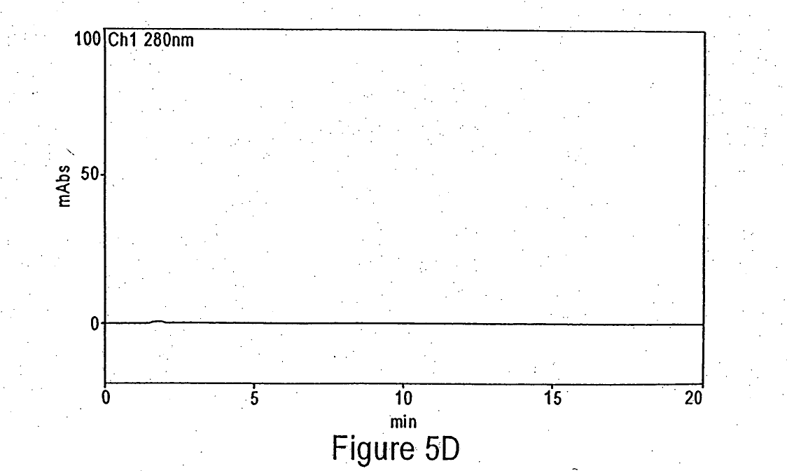

FIG. 5a of the drawing represent the HPLC profile of original plant extract.

FIG. 5b of the drawing represent the HPLC profile of permeate from extract.

FIG. 5c of the drawing represent the HPLC profile of recycling of permeate to obtain second permeate.

FIG. 5d of the drawing represent the HPLC profile of distilled water.

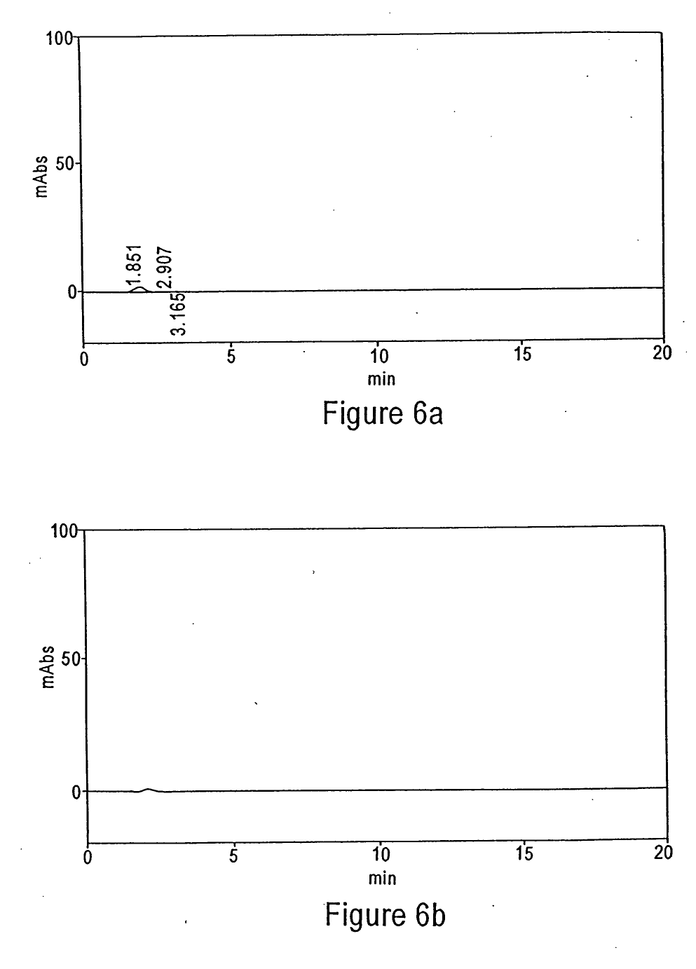

FIG. 6a of the drawing represent the HPLC of profile of first permeate.

FIG. 6b of the drawing represent the HPLC of second permeate.

The details of the device of present invention are shown in FIGS. 1 to 4 of the drawings accompanying this specification.

| Part No. | Description of the part |
|---|---|
| FIG. 1 | |
| 1 | herbal extract solution container |
| 2 | permeate solution container |
| 3 | filter to remove suspended particle from feed extract |
| 4 | Panel for control of different operations |
| 5 | main power supply switch |
| FIG. 2 | |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| FIG. 3 | |
| 15 | fabric filter through which clear solution enters into the |
| | membrane module (7) |
| 16 | air bleeding valve which can be opened to remove |
| | any trapped air in the system |
| FIG. 4 | |
| 17 | plastic body housing the membrane |
| 18 | thin film composite spiral membrane element for removal |
| | of water from extract under pressure |
| 19 | inlet for introducing the clear herbal extract solution |
| 20 | concentrate outlet for recycling the extract to the extract |
| | container (1) |
| 21 | permeate outlet for sending the water to |
| | the permeate container (2) |
| 22 | Rubber ‘O’ ring |
| 23 | By-pass seal for allowing the extract solution to |
| | pass through the membrane |

### DESCRIPTION OF THE DEVICE

In a physical embodiment of the device of the present invention, the membrane module (7) having 12 inches length, 2 inches diameter and an effective membrane area of 0.45 m² has a inlet for the extract solution and two outlets for the permeate (FIG. 6) and concentrated extract wherein the latter is recycled. Membranes having overall thickness of 140-160 microns is constructed as a thin film composite as described in the prior art and having a flux of 30 gallons per square foot of membrane area per 24 hours for NaCl separation with >95% rejection efficiency under standard test conditions of 225 psi applied pressure, 25° C. temperature and 2000 mg/L NaCl concentration in feed may be selected for concentrating the aqueous herbal extract solution. A filter vessel (3) with a fabric filter is provided before the pressure pump (6) so that the aqueous extract solution passes through filter vessel and then the clear solution enters into the membrane module. A diaphragm type pressure pump (6) is connected to the feed extract solution container in the rear chamber. The pump pressurises the feed extract and thereby assists the permeation of water through the membrane, and the pump also enables water to flow over the membrane surface at normal pressure for cleaning purpose in wash mode. The extract container (1) made of acrylic material having cylindrical shape of 300 mm length and 75 mm diameter and an effective volume of 1000 mL consists of (i) open lid at the top to add the extract solution and (ii) an outlet valve at the bottom to collect the aqueous concentrated extract solution. The permeate container (2) made of acrylic material having cylindrical shape of 300 mm length and 75 mm diameter and an effective volume of 1000 mL consists of an outlet valve at the bottom to collect the permeate (water) after passing through the membrane. The rear chamber is provided with a plurality of solenoid valves (,8-13) which are made of plastic materials. These solenoid valves are connected to AC power supply through control panel (4, 5) having ON and OFF switches, for operation during the “concentrate”, “drain” and “wash” mode.

The details of the device of the present invention and its operations are given as follows for: (i) Concentrate mode (ii) Drain mode and (iii) Wash mode.
(i) Concentrate mode: the aqueous extract container with an open lid at top and an outlet at the bottom is made of a acrylic material. It is cylindrical in shape having 30 cm length and 7.5 cm diameter. The extract container containing the dilute solution is connected to the pressure pump at the rear side of the device. The dilute solution is filtered with the help of filter, which is provided before the membrane module, so that only clear solution is allowed to pass through the TFC membrane using a by pass seal. At this stage, the ‘O’ ring at the top of the module separates the permeate from the concentrated extract. The permeate (water) is pumped to the permeate container and the concentrated is pumped into the extract container.
(ii) Drain mode: air compressor having an air blowing capacity of more than five CFM (cubic feet per minute) is connected to the open end of the solenoid valves though PVC pipelines. Air from the compressor is allowed to enter into the membrane module though the filter. After completion of the concentration operation, the concentrate is pressurised by compressed air, which in turn pressurises the membrane module and forces the hold up concentrate into the extract container. Permeate and extract solutions are then removed from the respective containers.
(iii) Wash mode: a tap, connected to a water reservoir, having a flow rate of 5 to 6 LPM (litres per minute) is connected to the open end of the solenoid valves though PVC pipelines. The water from the reservoir is allowed to flow at a constant rate and prior to entering the membrane module it passes though the pressure pump and the filter. The water will carry along with it the adhering materials and the sticky soluble materials and it is essential that before the concentrate mode is functional the membrane surface is thoroughly cleaned. The waste water though the solenoid valve is disposed into the drain.

The conventional technique of concentrating aqueous herbal extract solutions include evaporation using solar light or scientific equipment operating at high temperature. In the present invention, a device has been designed and developed wherein the dilute extract solution is pumped under pressure at ambient temperature through a spiral module containing thin film composite reverse osmosis membrane which allows water to pass through it and the extract is concentrated in a period shorter than 30 minutes. In this device it is possible to prevent the degradation of bioactive molecules which are thermally less stable.

The novelty of the device of the present invention, for concentrating plant extracts, comprising in combination (i) a spiral membrane module; (ii) a diaphragm type pressure pump; (iii) a filter vessel; (iv) a back pressure regulator; (v) series of solenoid valves; (vi) solution containers with inlets and outlets; is that it provides for continuous and speedy removal of water from the aqueous plant extracts at ambient temperature, thus preventing degradation of temperature sensitive bioactive molecules. Moreover, the concentration of plant extract, using spiral membrane module, may be achieved upto the level of 75-90 percent when the extract consists mainly of organic molecules and there is no major buildup of osmotic pressure due to other solutes in the extract. Another novelty of the invention is that there is no problem of froth formation which is sometimes a serious problem with the conventional method of concentration on a rotavap. Another important feature is the elimination of hold up volume which is especially critical when small quantities of extract have to be concentrated. Another important feature is the automatic washing cycle which minimises the problem of membrane fouling and contamination of extracts. Another novelty is that exactly the same method of concentration of extract can be pursued on large scale and there is no scale-up related issues since problems such as variations of surface area to volume on scale-up are absent.

The inventive steps of the device of the present invention which enable the above said novelty in combination of the sub system:
(i) Conception of an alternative to rotavap for concentration of aqueous herbal extracts.
(ii) Spiral membrane module containing a thin film composite membrane has been provided for removing water at ambient temperature under pressure.
(iii) Diaphragm type pressure pump has been provided for pressurising and creating turbulence over the membrane surface during the concentration mode to allow permeation with minimum bio-fouling of membrane, and washing of membrane surface during washing mode.
(iv) Filter vessel with fabric filter eliminates suspended particles and provides filtered extract to the membrane module to minimise fouling and choking.
(iv) The solenoid valves coupled with back pressure regulator provide flow of plant extract solution, water and air during the concentration, wash and drain mode, respectively.
(v) Touch screen control panel for different operations which are user-friendly and allow easy preparation of concentrated extract while maintaining cleanliness of system for repeat use.
(vi) The air bleeding valve is provided which on need basis can be opened to remove the blocked air for extract solution to flow.
(vii) Recovery of entire extract by eliminating hold up volume loss

The following examples are given by way of illustration and therefore should not be construed to limit the scope of the present invention.

### EXAMPLE 1

500 g of the seaweed, Ulva lactuca, was digested in 800 ml of cold water for 24 h and occasionally stirred. Dark amber coloured extract was separated, the volume was made up to 1L and taken in the extract solution container (FIG. 1). With the help of a pressure pump the dilute extract, prior to entering the membrane module, was made to pass through the filter vessel where suspending impurities were removed. The dilute dark coloured solution was the pumped into the membrane module where the reverse osmosis membrane allowed the water to pass and was collected as permeate and the concentrated solution was recycled to the extract container. Within a time period of 30 minutes, the permeate volume collected was 80 percent of the total feed volume and the concentrate retenate the balance. The permeate solution was analysed with high precision liquid chromatography (HPLC) and the results evinced no detectable polysaccharides. The permeate solution showed negative test for carbohydrate when checked with phenol sulphuric acid method. The concentrated retenate retained the plant constituents, salts and vital bioactive molecules. The same extent of concentration on a laboratory model Buchi rotavap took 4 h.

### EXAMPLE 2

350 g of the seaweed, Dictyota dichotoma, was digested in 600 ml hot water (70° C.) for 24 hours and occasionally stirred. After 24 hours, the dark coloured extract solution was separated, the volume was made upto 800 millilitres and taken in an extract solution container (FIG. 1). The dilute extract solution at 30° C. prior to passing through the membrane module was subject to filtration in the filter vessel to remove suspending impurities, with the help of a pressure pump. In the membrane module, the reverse osmosis membrane allowed water to pass, which was collected as permeate, and the concentrated solution was recycled to the extract container. Within a period of 20 minutes, 560 ml of permeate was collected and the remaining 240 ml was the concentrated retenate. The colourless permeate did not evince any detectable carbohydrate when tested with phenol sulphuric acid method. The high precision liquid chromatography (HPLC) analysis did not show the presence of any trace of polysaccharides. The concentrated retenate retained the plan constituents, salts and vital bioactive molecules.

### EXAMPLE 3

The aqueous plant extract bearing code CIMAP 1 was concentrated with the help of the novel device by 60-70%. FIG. 5 shows the hplc traces of the original plant extract (A), the permeate from the extract (B), the recycling of permeate to obtain second permeate (C), and distilled water (D). The first permeate contains <5% of the plant constituents while the amount is negligible in the second permeate whose hplc trace shows a flat baseline as for distilled water.

1. An improvised membrane-based device for speedier and effective concentrating of aqueous solution upto about 95%, as shown in FIGS. 1-4, wherein the device comprises:

| Part No. | Description of the parts of the device |
|---|---|
| 1 | herbal extract solution container |
| 2 | permeate solution container |
| 3 | filter to remove suspended particle from feed extract |
| 4 | Panel for control of different operations |
| 5 | main power supply switch |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| 15 | fabric filter through which clear solution enters into the |
| | membrane module (7) |
| 16 | air bleeding valve which can be opened to remove any |
| | trapped air in the system |
| 17 | plastic body housing the membrane |
| 18 | thin film composite spiral membrane element for removal |
| | of water from extract under pressure |
| 19 | inlet for introducing the clear herbal extract solution |
| 20 | Concentrate outlet for recycling the extract to the extract |
| | container (1) |
| 21 | permeate outlet for sending the water to the |
| | permeate container (2) |
| 22 | Rubber ‘O’ ring |
| 23 | By-pass seal for allowing the extract solution to pass |
| | through the membrane |

2. A device as claimed in claim 1, wherein the device is particularly effective in concentrating herbal extracts.

3. A device as claimed in claim 1, wherein the device can be scaled up without any change in basic design and operating parameters.

4. A device as claimed in claim 1, wherein the device maintains stability of the solution by functioning at room temperature, preferably about 25° C.

5. A device as claimed in claim 1, wherein the device concentrates the aqueous solution without frothing.

6. A device as claimed in claim 1, wherein the concentrate retains all constituents of the solution.

7. A device as claimed in claim 1, wherein the vertical container works as a reservoir for continuous supply of feed.

8. A device as claimed in claim 1, wherein the permeate container with outlet valve continuously removes water.

9. A device as claimed in claim 1, wherein the filter vessel coupled with air bleeding valve enables removal of suspended particles and trapped air, respectively, thus, allows only clear solution to flow into the membrane module.

10. A device as claimed in claim 1, wherein the membrane module containing spiral thin film composite membrane allows water to pass while retaining other components, and the solution to circulate in the system.

11. A device as claimed in claim 1, wherein the solenoid valves helps changing the path of aqueous solution/water during the drain/wash mode for operation.

12. A device as claimed in claim 1, wherein the pressure pump enables adequate pressure to be attained for continuous flow of aqueous solution.

13. A device as claimed in claim 1, wherein the control panel coupled with ON and OFF switch helps concentrating the aqueous solution, and continuously washing the membrane for optimum life.

14. A device as claimed in claim 1, wherein the membrane module has length and diameter in the ratio of about 6:1.

15. A device as claimed in claim 1, wherein the membrane has overall thickness ranging between 130 to 170 microns.

16. A device as claimed in claim 1, wherein the aqueous solution container has length and diameter in the ratio of about 4:1.

17. A device as claimed in claim 1, wherein the permeate container has length and diameter in the ratio of about 4:1.

18. A device as claimed in claim 1, wherein the solenoid valves controls the direction of the flow in modes selected from a group comprising concentrate mode, drain mode, and wash mode.

19. A method of manufacturing an improved membrane-based device for speedier and effective concentrating of aqueous solution upto 95%, wherein the said device is manufactured by assembling in a manner as shown in FIGS. 1-4.

| Part No. | Description of the part |
|---|---|
| FIG. 1 | |
| 1 | herbal extract solution container |
| 2 | permeate solution container |
| 3 | filter to remove suspended particle from feed extract |
| 4 | Panel for control of different operations |
| 5 | main power supply switch |
| FIG. 2 | |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| FIG. 3 | |
| 15 | fabric filter through which clear solution enters into the |
| | membrane module (7) |
| 16 | air bleeding valve which can be opened to remove any |
| | trapped air in the system |
| FIG. 4 | |
| 17 | plastic body housing the membrane |
| 18 | thin film composite spiral membrane element for removal |
| | of water from extract under pressure |
| 19 | inlet for introducing the clear herbal extract solution |
| 20 | concentrate outlet for recycling the extract to the extract |
| | container (1) |
| 21 | permeate outlet for sending the water to the |
| | permeate container (2) |
| 22 | Rubber ‘O’ ring |
| 23 | By-pass seal for allowing the extract solution to pass |
| | through the membrane |

20. A method as claimed in claim 19, wherein the device comprises:

| Part No. | Description of the parts of the device |
|---|---|
| 1 | herbal extract solution container |
| 2 | permeate solution container |
| 3 | Filter to remove suspended particle from feed extract |
| 4 | Panel for control of different operations |
| 5 | Main power supply switch |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| 15 | Fabric filter through which clear solution enters into the |
| | membrane module (7) |
| 16 | air bleeding valve which can be opened to remove any |
| | trapped air in the system |
| 17 | plastic body housing the membrane |
| 18 | thin film composite spiral membrane element for removal |
| | of water from extract under pressure |
| 19 | inlet for introducing the clear herbal extract solution |
| 20 | concentrate outlet for recycling the extract to the extract |
| | container (I) |
| 21 | permeate outlet for sending the water to the permeate |
| | container (2) |
| 22 | Rubber ‘O’ ring |
| 23 | By-pass seal for allowing the extract solution to pass |
| | through the membrane |

21. An improved process of speedier and effective concentrating of the aqueous solution upto about 95% using a membrane-based device of FIGS. 1-4, said process comprising steps of:
a. feeding the aqueous solution into the aqueous solution container (1),
b. filtering (3) the fed solution to remove suspended particles,
c. passing the resultant filtered solution into a membrane module (7),
d. segregating permeate and concentrate in the membrane module, and
e. recycling the concentrate multiple times to obtain the highly concentrated final concentrate.

22. A process as claimed in claim 21, wherein the device comprises:

| Part No. | Description of the parts of the device |
|---|---|
| 1 | herbal extract solution container |
| 2 | permeate solution container |
| 3 | Filter to remove suspended particle from feed extract |
| 4 | Panel for control of different operations |
| 5 | Main power supply switch |
| 6 | diaphragm type pressure pump through which the extract |
| | solution enters into the filter vessel (3) |
| 7 | membrane module through which the permeate is separated |
| | and the concentrate is recycled to the extract container (1) |
| 8-13 | Six solenoid valves which control the direction of the flow |
| | during the concentrate, drain and wash modes, respectively. |
| 14 | Back pressure regulator |
| 15 | Fabric filter through which clear solution enters into the |
| | membrane module (7) |
| 16 | air bleeding valve which can be opened to remove any |
| | trapped air in the system |
| 17 | plastic body housing the membrane |
| 18 | thin film composite spiral membrane element for removal |
| | of water from extract under pressure |
| 19 | inlet for introducing the clear herbal extract solution |
| 20 | concentrate outlet for recycling the extract to the extract |
| | container (1) |
| 21 | permeate outlet for sending the water to the permeate |
| | container (2) |
| 22 | Rubber ‘O’ ring |
| 23 | By-pass seal for allowing the extract solution to pass |
| | through the membrane |

23. A process as claimed in claim 21, wherein the process is particularly effective in concentrating herbal extracts.

24. A process as claimed in claim 21, wherein the device can be scaled up without any change in basic design and operating parameters.

25. A process as claimed in claim 21, wherein the process is conducted at room temperature, preferably about 25° C.

26. A process as claimed in claim 21, wherein the concentrate of the aqueous solution is without frothing.

27. A process as claimed in claim 21, wherein the concentrate retains all constituents of the solution.

28. A process as claimed in claim 21, wherein the vertical container works as a reservoir for continuous supply of feed.

29. A process as claimed in claim 21, wherein the permeate container with outlet valve continuously removes water.

30. A process as claimed in claim 21, wherein the filter vessel coupled with air bleeding valve enables removal of suspended particles and trapped air respectively, thus, allows only clear solution to flow into the membrane module.

31. A process as claimed in claim 21, wherein the membrane module containing spiral thin film composite membrane allows water to pass while retaining other components, and the solution to circulate in the system.

32. A process as claimed in claim 21, wherein the solenoid valves helps changing the path of aqueous solution/water during the drain/wash mode for operation.

33. A process as claimed in claim 21, wherein the pressure pump enables adequate pressure to be attained for continuous flow of aqueous solution.

34. A process as claimed in claim 21, wherein the control panel coupled with ON and OFF switch helps concentrating the aqueous solution, and continuously washing the membrane for optimum life.

35. A process as claimed in claim 21, wherein the membrane module has length and diameter in the ratio of about 6:1.

36. A process as claimed in claim 21, wherein the membrane has overall thickness ranging between 130 to 170 microns.

37. A process as claimed in claim 21, wherein the aqueous solution container has length and diameter in the ratio of about 4:1.

38. A process as claimed in claim 21, wherein the permeate container has length and diameter in the ratio of about 4:1.

39. A process as claimed in claim 21, wherein the solenoid valves controls the direction of the flow in modes selected from a group comprising concentrate mode, drain mode, and wash mode.

40. A process as claimed in claim 21, wherein the process helps eliminate the hold-up volume.

41. A process as claimed in claim 21, wherein the process minimizes the membrane fouling.

42. A process as claimed in claim 21, wherein the process prevents contamination of the solution.
